(19) United States
(12) Patent Application Publication
(10) Pub. No.: US 2016/0002975 A1
(43) Pub. Date: Jan. 7, 2016

(54) Boat Security Gate and Barrier System

(71) Applicant: TRUSTON TECHNOLOGIES, INC., Broussard, LA (US)

(72) Inventors: Erick B. Knezek, Lafayette, LA (US); Matthew A. Marcy, Annapolis, MD (US)

(21) Appl. No.: 14/764,218

(22) PCT Filed: Feb. 4, 2014
(86) PCT No.: PCT/US14/14537

§ 371 Date: Jul. 29, 2015

Related U.S. Application Data
(60) Provisional application No. 61/760,541, filed on Feb. 4, 2013.

(51) Int. Cl. E06B 11/02; E05D 7/00; F41H 11/05; E05B 65/00; E05B 47/00; E06B 11/04; E05B 61/00

(52) U.S. Cl. CPC E06B 11/022; E06B 11/04; E05D 7/00; E05B 61/00; E05B 65/0007; E05B 47/0001; F41H 11/05; E05D 2700/00; E05B 2047/0072; E05B 2047/005

(57) ABSTRACT

A security barrier system for controlling boat access to a protected area includes a barrier having an opening through it for boat passage. The barrier may be a fixed structure such as an earthen berm, or may be a floating barrier. A pair of spaced-apart support members, fixed in the waterbottom, are on either side of the opening. A gate is connected to one of the support members and spans the opening. A remotely operable latch means locks the gate closed, preventing passage. In one embodiment, a boat remotely unlocks the gate and pushes the gate open, then flex members return the gate to a closed and locked position. In another embodiment, particularly for locations with significant water level changes, the gate moves vertically on floats in response to water level, and a remotely operable system both unlocks/locks the gate and moves it between closed and open positions.

### CROSS REFERENCE TO RELATED APPLICATIONS

This regular U.S. patent application claims priority to U.S. provisional patent application Ser. No. 61/760,541, filed Feb. 4, 2013, for all purposes.

### BACKGROUND

This invention relates to apparatus used to control access by boat into restricted or protected areas, such as harbors and the like. For security reasons, it is desirable to have positive barrier means by which to control access to a protected area by boats and floating or subsurface craft of any sort. As used in this application, the term “boat” is meant broadly, to include any type of water craft, regardless of size, purpose, mode of propulsion, whether floating or subsurface, etc.

While such barriers could take many different forms, examples include earthen or rip-rap structures effectively forming levees or dikes; fences in the water comprising a plurality of pilings driven into the soil underlying the water; or floating barriers. However, all of these barriers must provide some means to permit authorized boats to enter the controlled area, namely a gate spanning an opening in the barrier.

### SUMMARY

One boat security gate and barrier system, embodying the principles of the present invention, comprises a swinging gate which spans an opening in a boat barrier. One end of the gate is hingedly mounted on a first support member, for example a first piling driven into the waterbottom. One or more resilient flex members, or spring hinges, connect the gate to the first piling, and provide a force which biases the gate to a closed position. In one embodiment, the flex members comprise non-metallic composite or elastomer members, which do not degrade or corrode in a marine environment. The other end of the gate comprises a latch means which latches into a second, spaced-apart support member, for example a second piling driven into the waterbottom. The space between the first and second support members defines the opening through the security barrier. The latch is remotely operable by radio frequency devices or similar means well known in the art. As a boat approaches the closed gate, the latch is unlatched and the boat pushes the gate open. After passage of the boat, the spring hinges swing the gate back to the closed position and the latch latches it closed and locked.

A second embodiment of the boat security gate and barrier system, embodying the principles of the present invention, again comprises a pair of spaced-apart support members fixed to the waterbottom, for example pilings driven into the waterbottom, the space between them defining the opening through the security barrier for boat passage. In this embodiment, the gate is supported at the water's surface by one or more floats, and is connected at one end to the first support member in such a manner that it (the gate) can move up and down in response to water level, e.g. due to tidal movement. The other end of the gate comprises a latch means which latches to the second support member, either directly or via an intermediate structure attached to the second support member (for example, a vertical member or latch post attached to and spaced apart from the second support member). In one embodiment, the float supporting the gate is a generally cylindrical float which encircles the first support member, and is free to move up and down the first support member, carrying the gate with it. The floating barrier sections on either side of the first and second support members also attach to floats, so that they are attached to the first and second support members but can move up and down in response to water level.

### BRIEF DESCRIPTION OF THE DRAWINGS

FIG. 1 is a front view of a boat security gate embodying the principles of the present invention.

FIG. 2 is a detailed view of the spring hinge and its attachment, along the section line B-B in FIG. 1.

FIG. 3 is a side view of the spring hinge assembly.

FIG. 4 is a section view of the gate.

FIG. 5 is an end-on view of the spring hinge.

FIGS. 6 and 7 are top and side views of the flexible member of the spring hinge.

FIG. 8 is a perspective view of another embodiment of the boat security gate and barrier system, with the gate closed.

FIG. 9 is a view of the embodiment of FIG. 8, with the gate open.

FIG. 10 is another view of the embodiment of FIG. 8, where the water level has risen and the gate and barrier elements are at a higher elevation.

FIG. 11 shows another gate and float arrangement.

FIG. 12 shows one possible embodiment of the latch means.

FIG. 13 shows another embodiment of the latch means.

FIG. 14 shows an embodiment of the remotely operable means for opening and closing the gate.

### DESCRIPTION OF THE PRESENTLY PREFERRED EMBODIMENT(S)

### A First Embodiment

An apparatus embodying the principles of the present invention comprises a boat security gate, preferably comprising a remotely operable means for opening/closing of the latch means which secures the gate closed. The boat security gate is hingedly attached to support members, for example pilings, fixed in the waterbottom, and is positioned with respect to the surface of the water such that boats cannot pass through the opening in the security barrier controlled by the gate.

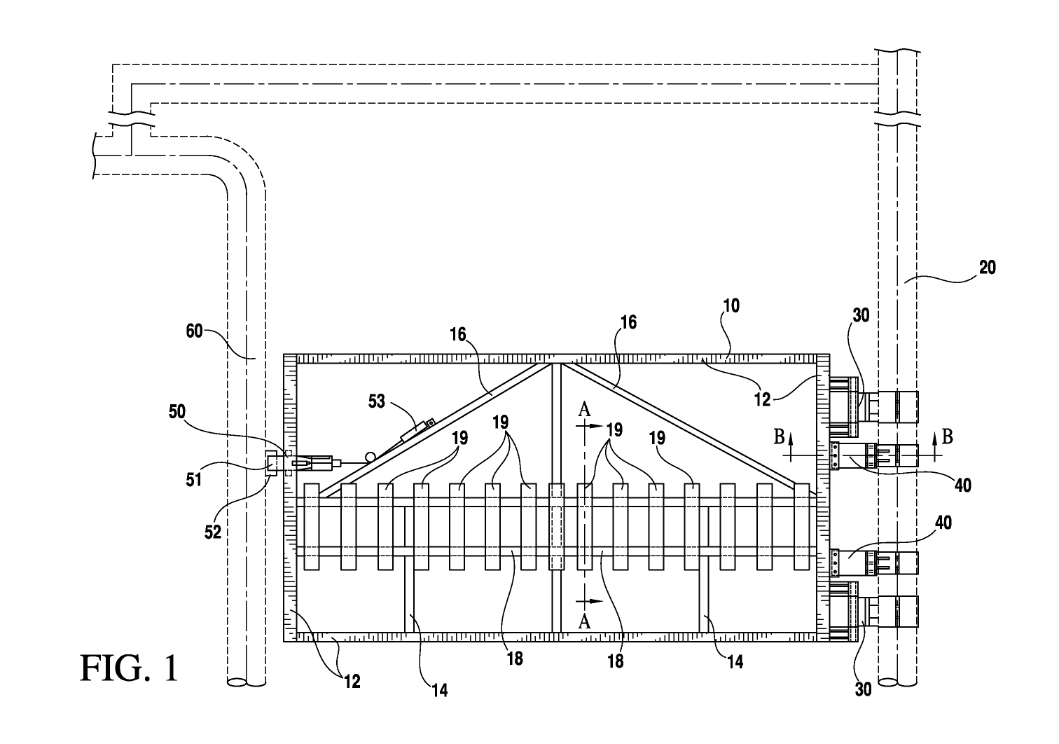

With reference to FIGS. 1-7, in an exemplary embodiment, gate 10 is hingedly attached to a first support member, namely piling 20, by support hinges 30. Support hinges are of sufficient capacity to withstand the weight of gate 10, all environmental forces imposed on gate 10, and forces resulting from any attempt at forced entry through the gate. Gate 10 is movable between a first, closed position wherein gate 10 blocks the opening between first and second support members, namely pilings 20 and 60, and a second open position wherein a boat can pass through the opening.

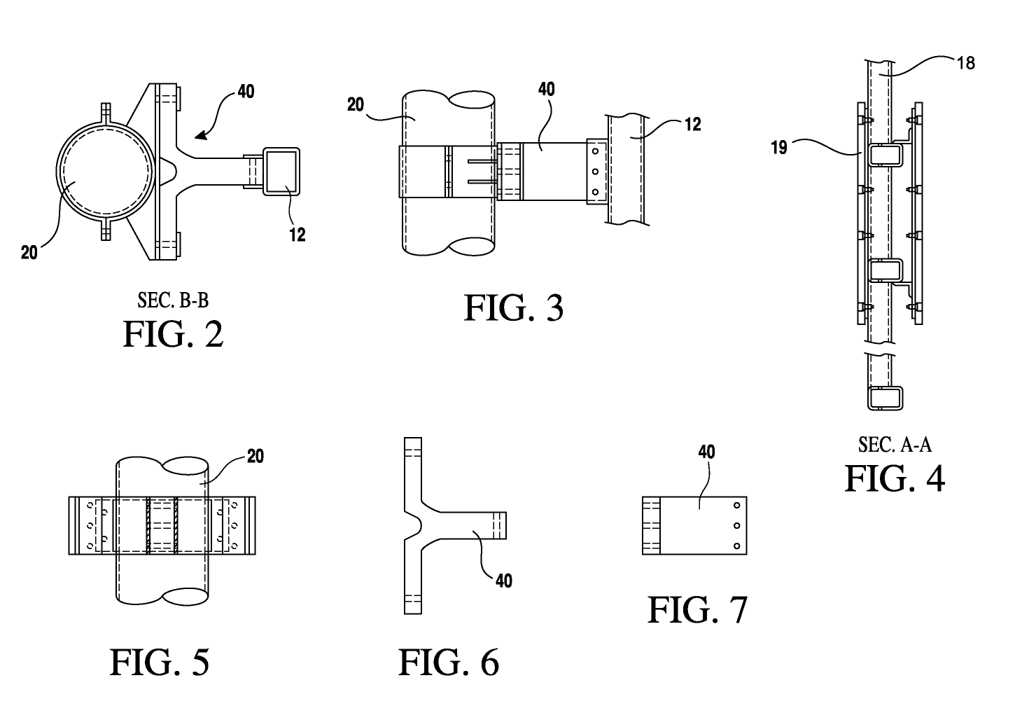

Spring hinges 40 also connect gate 10 to piling 20, as seen in FIG. 1. Spring hinges 40 are seen in further detail in FIG. 2, which is a section view through B-B in FIG. 1; in FIG. 3, which is a side view in more detail; FIG. 6, which is a top view of spring hinge 40; and FIG. 7, which is a side view of spring hinge 40. Spring hinges 40, as the name suggests, provide a closing force to move gate 10 to a closed position, as shown in FIG. 1, after passage of an authorized boat. Spring hinges 40 may comprise various types of spring elements, e.g. coil springs, or preferably comprise a non-metallic, “plastic,” composite or elastomer material, which has resilient and flexible properties but is non-corrosive in a marine environment. Various materials may provide the needed resilient/restorative forces needed for the gate closure function. The flexing of the elastic material provides the spring force needed for the closing function. Spring hinge 40 may be formed in desired dimensions and shapes by molding or other forming methods known in the art.

A latch means 50 is mounted on gate 10 opposite support hinges 30 and spring hinges 40, and provides the latching function with piling 60. Latch 50 has an auto-latch function that allows it to latch when gate 10 passes by latch receiver 52 mounted on piling 60. It is understood that a plunger 51 in latch means 50 moves axially to engage latch receiver 52. Latch means 50 preferably has both a manual and power (for example, electrical or hydraulic) actuator 53 that moves plunger 51 and unlocks gate 10, allowing gate 10 to be pushed open by a boat or opened by mechanical means. Latch means 50, and more particularly actuator 53, is preferably remotely operable by radio/electric means known in the art. Latch means 50 is designed to have sufficient capacity to resist forces resulting from any attempt at forced entry through gate 10. It is understood that latch means 50 could be mounted on piling 60, instead of on gate 10, if desired.

Gate 10 may have various configurations, generally comprising a rectangular frame with cross-pieces (vertical, horizontal, and/or diagonal) as desired or necessary for strength and to provide a barrier to passage. In the exemplary embodiment in FIG. 1, gate 10 comprises a rectangular outer frame 12, a plurality of vertical cross pieces 14, diagonal cross pieces 16, and horizontal cross pieces 18. Preferably, a plurality of bumpers 19 are fixed to gate 10, for example on horizontal cross pieces 18; bumpers 19 may comprise a steel base with a resilient face surface (see FIG. 4) for boats pushing gate 10 open. Generally, the structural members of gate 10 would be made of steel, aluminum, or other suitable high strength materials.

Dimensions of gate 10, spacing between pilings 20 and 60 (and the resulting size of the opening in the security barrier) and the other components may be changed to suit particular applications.

### A Second Embodiment

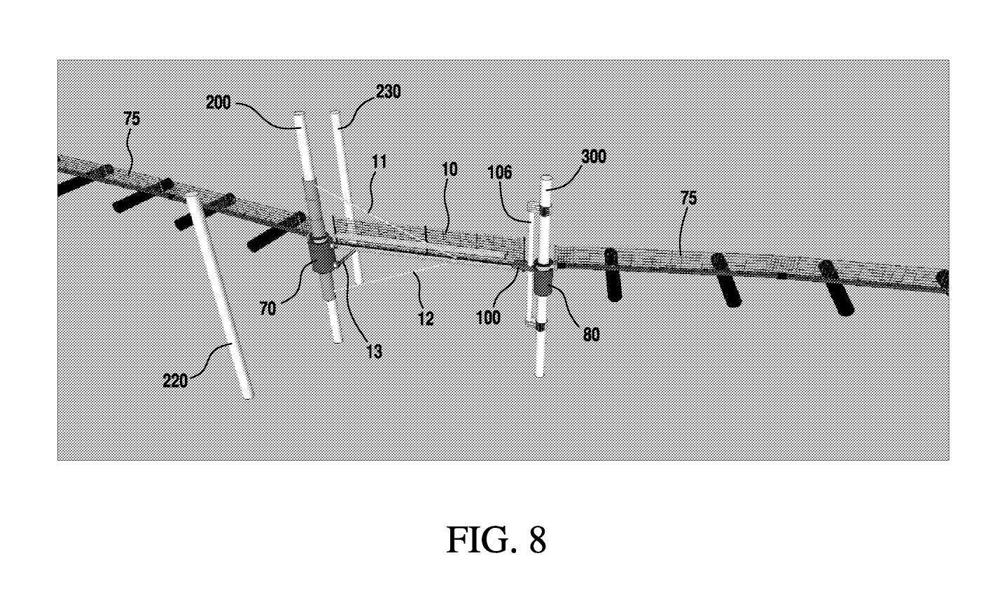

A second embodiment of the boat security gate and barrier system, embodying the principles of the present invention, is shown in FIGS. 8-13. This embodiment preferably comprises a security barrier with an opening therethrough, and first and second spaced-apart support members fixed to the waterbottom, for example pilings driven into the waterbottom, the space between them defining the opening through the security barrier for boat passage. FIG. 8 is a general perspective view of the system.

In this embodiment, gate 10 is supported at or proximal to the water's surface by one or more floats, and is connected at one end to the first support member 200 in such a manner that it (the gate) can move up and down in response to water level, e.g. due to tidal movement. The other end of gate 10 comprises a latch means which latches to second support member, either directly or via an intermediate structure attached to the second support member 300 (for example, a vertical member attached to and set apart from the second support member).

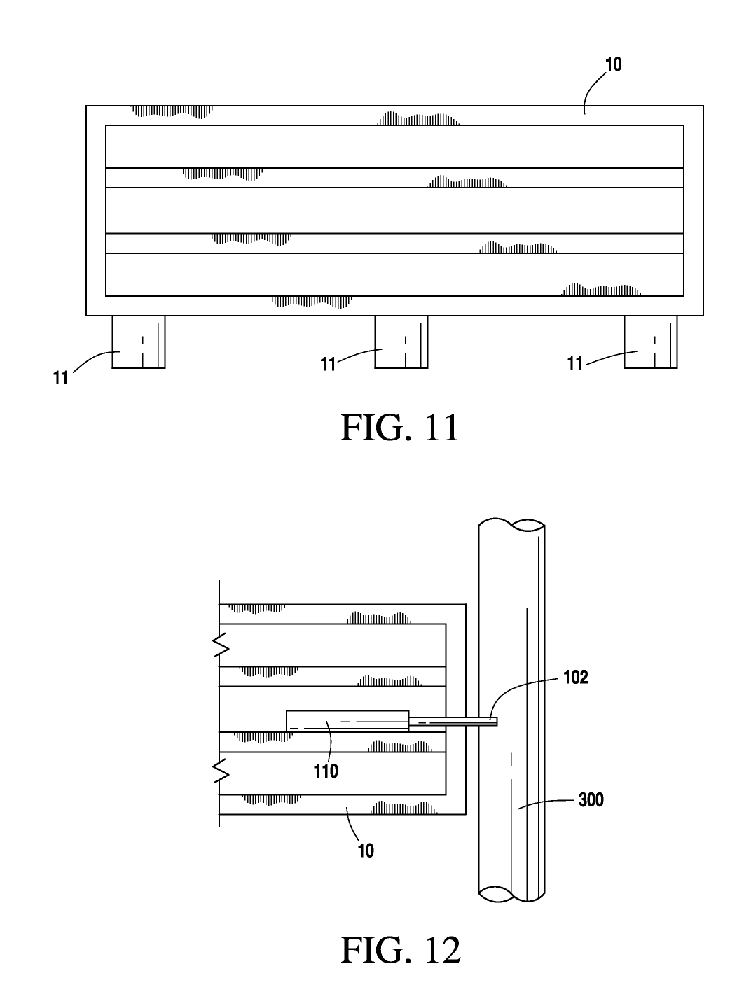

In one embodiment, see FIG. 8, the float supporting gate 10 is a cylindrical float 70 which encircles the first support member 200, and is free to move up and down first support member 200 in response to water level. In another embodiment, FIG. 11, gate 10 has one or more floats 60 attached thereto, if desired in combination with cylindrical float 70 previously disclosed.

As shown in FIGS. 8-10, the barrier system may comprise a plurality of floating barrier sections 75. Preferably, floating barrier sections 75 on either side of the first and second support members 200, 300 also attach to cylindrical floats 70 and 80 which encircle first and second support members 200 and 300, so that they are connected to first and second support members 200 and 300 but can move up and down in response to water level. Alternatively, simple cylindrical (non-floating) collars encircle the support members.

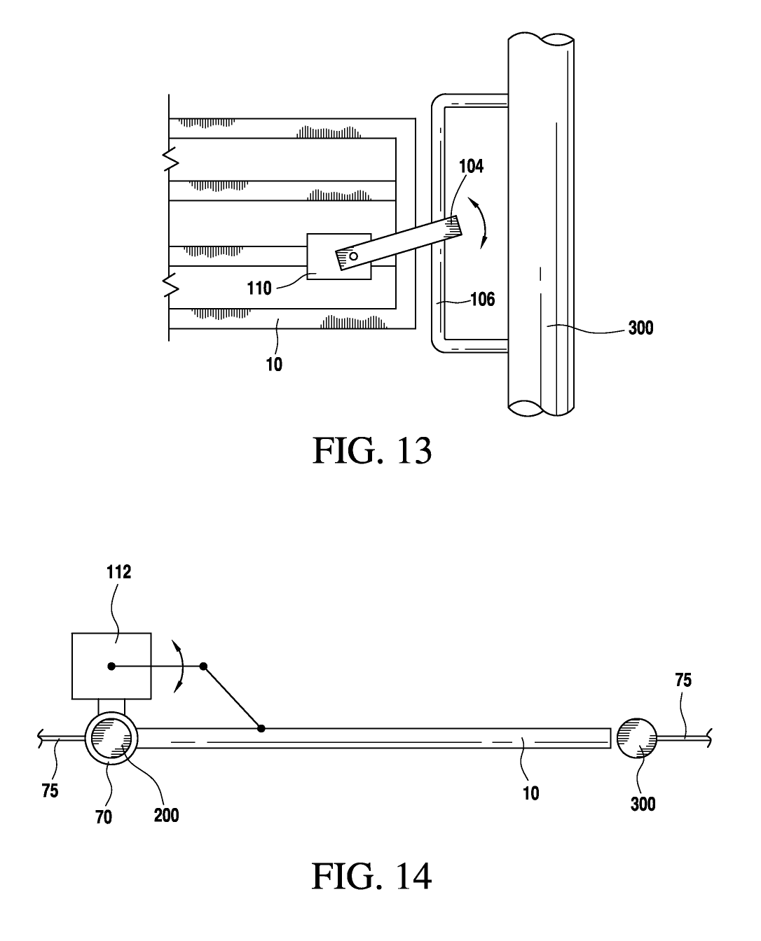

The locking means 100 may take various forms. One possible embodiment comprises a sliding lock member 102, similar to that in the first embodiment, which engages second support member 300, as shown in FIG. 12. Another embodiment of locking means 100 comprises a rotating arm 104, which engages a lock post 106, which may be either attached to second support member 300, as seen in FIG. 13, or may alternatively be itself fixed in the waterbottom. Both of these embodiments of lock means 100 comprise a means for remotely operating said lock means, denoted as 110, which either slides lock member 102 or rotates arm 104, as the case may be. The means for remotely operating the lock means 110 comprises electric motors, gearing, radio signal detection and other components as well know in the relevant art. A variety of remotely operable means are within the scope of the invention. It is understood that lock means 110 could be mounted on second support member 300, if desired.

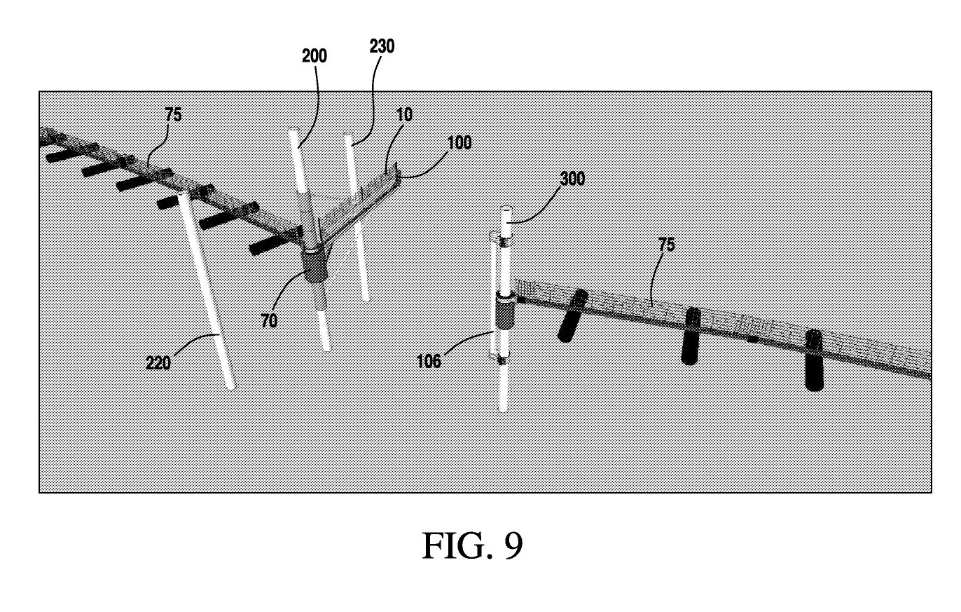

Preferably, a means for remotely opening and closing gate 10, that is for remotely moving gate 10 between the first closed position (as in FIG. 8) and the second open position (as in FIG. 9) is provided, denoted as element 112, as shown in FIG. 14. The means for remotely opening and closing gate 10, namely element 112, may comprise electric motor-driven control/linkage arms, gearing, controllers, etc., all known in the relevant art field, such as those used for opening and closing gates on land. The means for remotely opening and closing 112 may be operable from a boat, or may be operable from a nearby fixed location, e.g. from a guard facility with personnel to remotely open and close the gate upon security concerns being satisfied. It is understood that a variety of other gate opening/closing mechanisms could be used.

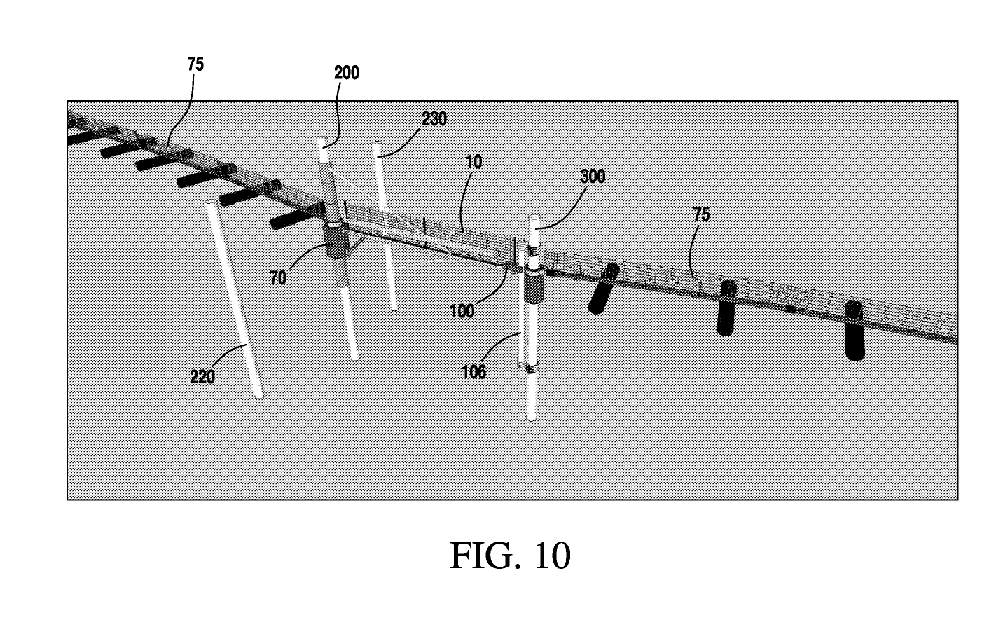

As previously described, and as can be readily understood from the drawings, gate 10 and its associated equipment, along with barrier sections 75, can move vertically in response to water level, as influenced by tides or other forces. FIG. 8 shows the system in a relatively low water level setting. FIG. 10 shows the system in a relatively high water level setting.

Additional support members 220 and 230 may be provided to limit the degree of rotational movement of gate 10. The structure of gate 10 may be as shown in FIG. 1, with horizontal, vertical, and diagonal members as appropriate for strength. Additional bracing members, shown as 11, 12 and 13 (noted only in FIG. 8) may be provided as needed.

### Conclusion

While the preceding description contains many specificities, it is to be understood that same are presented only to describe some of the presently preferred embodiments of the invention, and not by way of limitation. Changes can be made to various aspects of the invention, without departing from the scope thereof. For example:

dimensions and materials can be changed to suit particular applications;

the gate may extend a desired distance both above and below the water's surface, to thwart entry by surface and below surface watercraft;

a variety of latch and lock means may be employed to lock the gate closed against attempted entry, and such means may be operable from a boat or from nearby fixed locations;

a variety of resilient means may be used to move the gate back to a closed position, in the first embodiment described;

a variety of remotely operable power opening and closing means may be used, to open and close the gate, in the second embodiment;

the float or floats used to position the gate at the desired location proximal the surface of the water, in variable water level situations, may take various forms and shapes, and may completely or partially encircle the support members or otherwise be generally laterally constrained, yet free to move vertically, or alternatively may be fixed to the gate itself.

Therefore, the scope of the invention is to be determined not by the illustrative examples set forth above, but by the appended claims and their legal equivalents.

We claim:

1. An apparatus for controlling boat passage through an opening in a barrier, said barrier disposed in a waterbody with an underlying waterbottom, comprising:
first and second supports at either side of said opening, said supports fixed in said waterbottom;
a gate hingedly attached to said first support and substantially spanning a distance between said supports, said gate disposed proximal a surface of said waterbody and movable between a first closed position wherein said gate blocks boat passage through said opening, and a second open position wherein a boat can travel through said opening;
one or more resilient flex members attached to said gate and biasing said gate toward said first closed position;
a latch means locking said gate in said first closed position, said latch means remotely operable from a boat,
whereby a boat approaching said gate can unlatch said latch means and push said gate open to pass through said opening, and wherein said flex members return said gate to said first closed position and said latch means lock said gate in that position, after passage of said boat.

2. The apparatus of claim 1, wherein said latch means comprises a sliding latch member.

3. The apparatus of claim 1, wherein said flex members are formed from elastomer.

4. The apparatus of claim 1, wherein said barrier comprises floating barrier members.

5. A method of controlled boat access to a protected area of a waterbody, said waterbody having a waterbottom underlying same, comprising the steps of:
a) providing a barrier to boat passage to said protected area, said barrier comprising an opening therein of sufficient size for boat passage therethrough;
b) providing a gate system controlling boat passage through said opening, said gate system comprising:
first and second supports at either side of said opening, said supports fixed in said waterbottom;
a gate hingedly attached to said first support and substantially spanning a distance between said supports, said gate disposed proximal a surface of said waterbody and movable between a first closed position wherein said gate blocks boat passage through said opening, and a second open position wherein a boat can travel through said opening;
one or more resilient flex members attached to said gate and biasing said gate toward said first closed position;
a latch means locking said gate in said first closed position, said latch means remotely operable from a boat,
c) from a boat approaching said gate, unlatching said latch means; and
d) pushing said gate open with said boat, enabling passage through said opening, wherein said flex members return said gate to said first closed position and said latch means lock said gate in that position, after passage of said boat through said opening.

6. A system for controlling boat passage through an opening in a barrier, said system disposed in a waterbody with an underlying waterbottom, comprising:
first and second supports at either side of said opening, said supports fixed in said waterbottom;
a gate hingedly attached to said first support and substantially spanning a distance between said supports, said gate comprising one or more floats which position said gate proximal a surface of said waterbody, said gate vertically movable in response to variations in the level of said surface, said gate and movable between a first closed position wherein said gate blocks boat passage through said opening, and a second open position wherein a boat can travel through said opening;
a means for locking said gate in said first closed position, said means for locking said gate being remotely operable from a boat;
a means for moving said gate from said first closed position to said second open position, said means for moving said gate being remotely operable from a boat.

7. The apparatus of claim 6, wherein said barrier comprises a plurality of floating barrier sections, said floating barrier sections movable in response to water level, said floating barrier sections attached to said first and second supports.

8. The apparatus of claim 6, wherein said or or more floats comprise a cylindrical float disposed around said first support and movable vertically up and down said first support, said gate attached to said cylindrical float.

9. The apparatus of claim 8, wherein said floating barrier sections are attached to said first and second supports by cylindrical members disposed around said supports.

10. The apparatus of claim 9, wherein said means for locking said gate in said first closed position comprises a lock post attached to said second support, and a latch disposed on said gate, said latch engaging said lock post.

11. The apparatus of claim 10, wherein said latch comprises a sliding member.

12. The apparatus of claim 10, wherein said latch comprises a rotating arm.

13. A method of controlled boat access to a protected area of a waterbody, said waterbody having a waterbottom underlying same, comprising the steps of:
a) providing a barrier to boat passage to said protected area, said barrier comprising an opening therein of sufficient size for boat passage therethrough;
b) providing a gate system controlling boat passage through said opening, said gate system comprising:
a gate hingedly attached to said first support and substantially spanning a distance between said supports, said gate comprising one or more floats which position said gate proximal a surface of said waterbody, said gate vertically movable in response to variations in the level of said surface, said gate and movable between a first closed position wherein said gate blocks boat passage through said opening, and a second open position wherein a boat can travel through said opening;
a means for locking said gate in said first closed position, said means for locking said gate being remotely operable from a boat;
a means for moving said gate from said first closed position to said second open position, said means for moving said gate being remotely operable from a boat;
c) unlocking said means for locking said gate;
d) moving said gate to said second open position;
e) moving said boat through said opening;
f) after said boat has cleared said opening, moving said gate to said first closed position, and locking said gate in that position.
